(19) United States
(12) Patent Application Publication
(10) Pub. No.: US 2002/0000404 A1
(43) Pub. Date: Jan. 3, 2002

(54) Filtration element for severe service applications

(76) Inventors: Michael Mutsakis, Brooklyn, NY (US); John P. Puglia, Townsend, MA (US); Gerald M. Freedland, Beverly, MA (US); Thomas W. Eagar, Belmont, MA (US); Harold R. Larson, Belmont, MA (US)

Correspondence Address: Michael B. Hurd, SHOOK, HARDY & BACON L.L.P., 1200 Main Street, Kansas City, MO, 64105-2118, US

(21) Appl. No.: 09/809,818

(22) Filed: Mar. 16, 2001

Related U.S. Application Data
(60) Provisional application No. 60/190,235, filed on Mar. 17, 2000.
(60) Provisional application No. 60/205,786, filed on May 19, 2000.

(51) Int. Cl. B01D 25/00

(52) U.S. Cl. 210/323.2

(57) ABSTRACT

A filtration module is provided using metallic interconnect tubes that are sealed to carbon or ceramic based tubular filtration elements and that are also sealed to metallic tubesheets which are sealed to a filter housing. A sealed joint is formed between the interconnect tubes and the filtration elements using a metal alloy and an optional metallic plating on the filtration elements. In order to reduce or prevent undesired wicking of the alloy into the filtration element, refractory small solid particles may be added to or formed in the alloy to block the pores and channels in the filtration element at the site of the joint. Wicking can also be reduced by induction, torch or other type of heating where only those portions of the filtration element at the site of the joint is heated so that temperatures adjacent the site are below the solidus temperature of the alloy. When sealing on the inside of the wall of the filtration element, a compressive force may be applied to the outside of the wall during formation of the sealed joint to reduce the opportunity for the joint to fail as a result of the different coefficients of thermal expansion of the filtration element and the interconnect tubes. The use of the metallic interconnect tubes and tubesheets, rather than the conventional elastomers, polymers and rubbers, allows the filtration module to better withstand the high temperatures and corrosive fluids often present in severe service applications. The filtration elements may be reverse osmosis, nanofiltration, ultrafiltration or microfiltration membranes.

### CROSS-REFERENCE TO RELATED APPLICATIONS

This application claims the benefit of provisional application Ser. Nos. 60/190,235 and 60/205,786 filed Mar. 17, 2000 and May 19, 2000, respectively.

### BACKGROUND OF THE INVENTION

This invention relates generally to mineral-based filtration membranes and, more particularly, to filtration modules containing such membranes and methods of making same.

Hollow tube filtration elements are commonly used within a tubular pressure housing to separate suspended particles, solutes and other components in fluid streams. These filtration elements utilize a semipermeable membrane that permits permeation flow of a solvent as well as solutes of a preselected size while rejecting passage of larger solutes and suspended solids. That portion of the fluid stream that passes through the membrane is typically referred to as the permeate and the remaining or “rejected” portion of the stream is known as the retentate or concentrate. The size of particles that can be separated from the fluid stream depends on the size of the openings in the membrane material and other factors. Membranes that reject particles having the smallest mean diameter of less than 10⁻³ microns are referred to as reverse osmosis membranes. Nanofiltration membranes separates particles within the range of about 10⁻³ to 10⁻² microns, while ultrafiltration membranes separate particles within the range of 10⁻² to 10⁻¹ microns, and microfiltration membranes separate particles larger than 10⁻¹ microns.

Conventional tubular filtration elements of the type described above comprise organic and, more recently, carbon and ceramic semipermeable membranes applied to a porous and fluid permeable tubular substrate or support. The filtration elements are straw-like in configuration with a hollow axial fluid passage defined by an elongated cylinder with an inner and outer wall. When material to be filtered is flowing inside the axial flow passage defined by the elongated cylinder, the outer wall is formed from a substrate with large pore openings while the inner wall is lined with a semipermeable membrane. Permeate passes through the semipermeable membrane and then through the substrate and away from the outside of the cylinder while the semipermeable membrane blocks flow of the concentrate. In reverse, when the material to be filtered is flowing on the outside of the cylinder, the semipermeable membrane may be on the outside wall of the cylinder to permit the permeate to pass through the semipermeable membrane and then through the substrate while blocking the flow of concentrate. The permeate then exits through the axial fluid passage defined by the elongated cylinder.

In one type of arrangement, a plurality of the individual filtration elements are bundled together in parallel and spaced apart relationship, with both ends of the filtration elements extending through a polymeric potting material that forms a type of plug known as a tubesheet at both ends of the housing. Together, the bundled filtration elements and tubesheets constitute a module which can be inserted within and sealed against the inner diameter of a pressure housing by polymeric O-rings or other types of polymeric gaskets, mineral or metallic gaskets, or potted directly into the housing. In another type of arrangement, individual filtration elements, which can be either individual tube filtration elements or a multi-channel monolothic design with as many as nineteen or more parallel channels in a filtration element, are sealed at both ends with polymeric sealing rings or gaskets pushed against a plate with holes. The plate is secured and sealed to the housing.

In a typical application, the filtration modules described above are used by introducing a fluid feed stream which contains suspended particles and/or solutes into a feed end of the housing. The feed stream then enters the open ends of the filtration elements and travels axially along the hollow passage, with the permeate passing through the wall for collection and removal in the surrounding volume. The concentrate remains within and flows axially along the hollow passage until it is removed at the end of the housing opposite from the feed end. In other applications, the feed stream is introduced into the surrounding volume and the permeate enters the hollow passages of the filtration elements after passing through the outer walls of the filtration elements.

Carbon-based and ceramic-based semipermeable membranes and substrates are better suited for certain applications than organic membranes and substrates because they are more resistant to degradation. These mineral-based filtration elements, however, may still be unsuited for use in severe service applications, such as when the feed stream contains organic chemicals and solvents, or when the feed stream is at an elevated temperature, because the polymeric potting material or polymeric sealing material which is used to form a seal around the ends of the filtration elements may degrade and cause leaks to occur. A need has thus developed for a way to seal the filtration elements without having to use elastomeric, polymeric or rubber materials so that the filtration modules are better adapted for use in severe service environments.

### SUMMARY OF THE INVENTION

A filtration assembly of the present invention utilizes a plurality of elongated hollow filtration elements arranged in generally parallel and spaced apart relationship. Each filtration element includes an elongated tubular wall which forms an inner axial fluid flow passage. The wall includes a semipermeable, porous membrane and optional substrate which permits permeation flow of a solvent and solutes of a preselected size through the membrane while rejecting passage of larger solutes and suspended solids. The filtration element has longitudinally opposite ends and is formed of a carbon or ceramic based material. One end of a metallic interconnect tube is sealed to an end of the wall of the filtration element using a metal alloy. An optional metallized coating may be formed on the surface of the wall of the filtration element. The other end of the interconnect tube may be sealed to a metallic plug or tubesheet that can be sealed against the inner diameter of a pressure housing to form a reverse osmosis, nanofiltration, ultrafiltration or microfiltration filter that can withstand the high temperatures and corrosive fluids which may be present in severe service applications.

In another aspect, the invention is directed to a method of forming the filtration assembly by inserting the metallic interconnect tube a preselected axial distance within or outside of an end of the elongated hollow filtration element, forming a sealing joint at a preselected portion of the interconnect tube and the filtration element by heating at least the preselected portion to a temperature above the liquid temperature and preferably above the liquidus temperature of the preselected metal alloy, contacting the metal alloy in its liquid form with the preselected portion, and then allowing the metal alloy at the preselected portion to cool to a temperature below a solidus temperature of the metal alloy.

The metal alloy used in the present invention contains one or more components capable of forming a chemical or mechanical bond with the filtration element. In order to reduce or prevent undesired wicking of the alloy into the filtration element, refractory small solid particles may be added to or formed in the alloy to block the pores and channels in the filtration element at the site of the joint. Wicking can also be reduced by heating only those preselected portions of the filtration element at the site of the joint so that temperatures adjacent to the site are below the solidus temperature of the alloy. When forming a seal on the inside diameter of a filtration element, a compressive force may be applied to the outside diameter of the filtration element during formation of the sealed joint to reduce the opportunity for the joint to fail as a result of the different coefficients of thermal expansion of the filtration element and the interconnect tubes. Similarly, when forming a seal on the outside diameter of the filtration element, an expansion force may be applied to the inside diameter of the filtration element.

### BRIEF DESCRIPTION OF THE DRAWINGS

In the accompanying drawings which form part of the specification and in which like reference numerals are used to indicate like parts in the various views:

FIG. 1 is a perspective view of a filter constructed in accordance with the present invention;

FIG. 2 is a side elevation view of the filter taken in vertical section along line 2-2 of FIG. 1 and showing the construction of the filtration module positioned within the filter housing;

FIG. 3 is a fragmentary side elevation view of a single filtration element taken in vertical section along line 3-3 of FIG. 2;

FIG. 4 is fragmentary side elevation view of another embodiment of the filtration element taken in vertical section to show internal construction details;

FIG. 5 is fragmentary side elevation view of a third embodiment of the filtration element taken in vertical section to show internal construction details;

FIG. 6 is fragmentary side elevation view of a fourth embodiment of the filtration element taken in vertical section to show internal construction details;

FIG. 7 is fragmentary side elevation view of a fifth embodiment of the filtration element taken in vertical section to show internal construction details.

### DESCRIPTION OF THE PREFERRED EMBODIMENTS

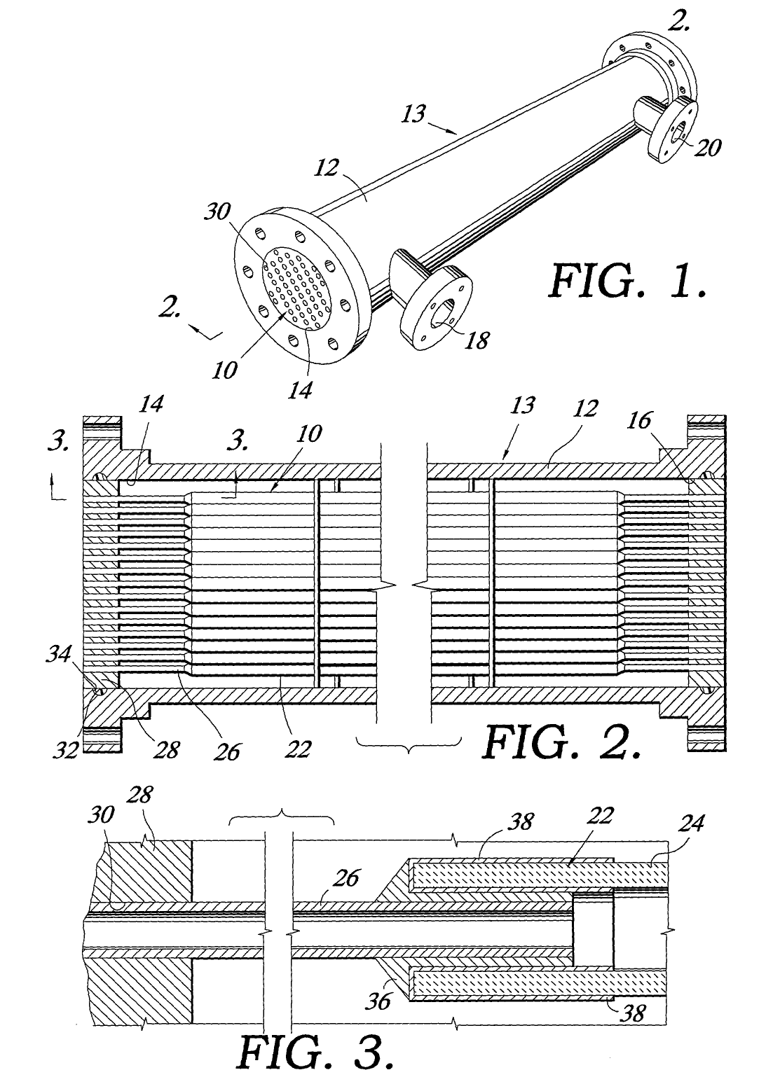

Referring now to the drawings in more detail, and initially to FIGS. 1 and 2, a filtration module of the present invention is designated generally by the numeral 10 and is shown positioned within a pressure housing 12 to form a filter 13. A flanged feed inlet 14 is positioned at one end of the housing 12 for introducing a fluid feed stream at a preselected pressure and flow rate into the housing 12 where it flows through the filtration module 10 and is separated into a permeate stream and a concentrate stream. A flanged outlet 16 is positioned at the opposite, outlet end of the housing 12 for axial removal of the concentrate stream from the housing 12. Two smaller flanged outlets 18 and 20 are located near the ends of the housing for removal of the permeate stream from the internal volume within the housing 12.

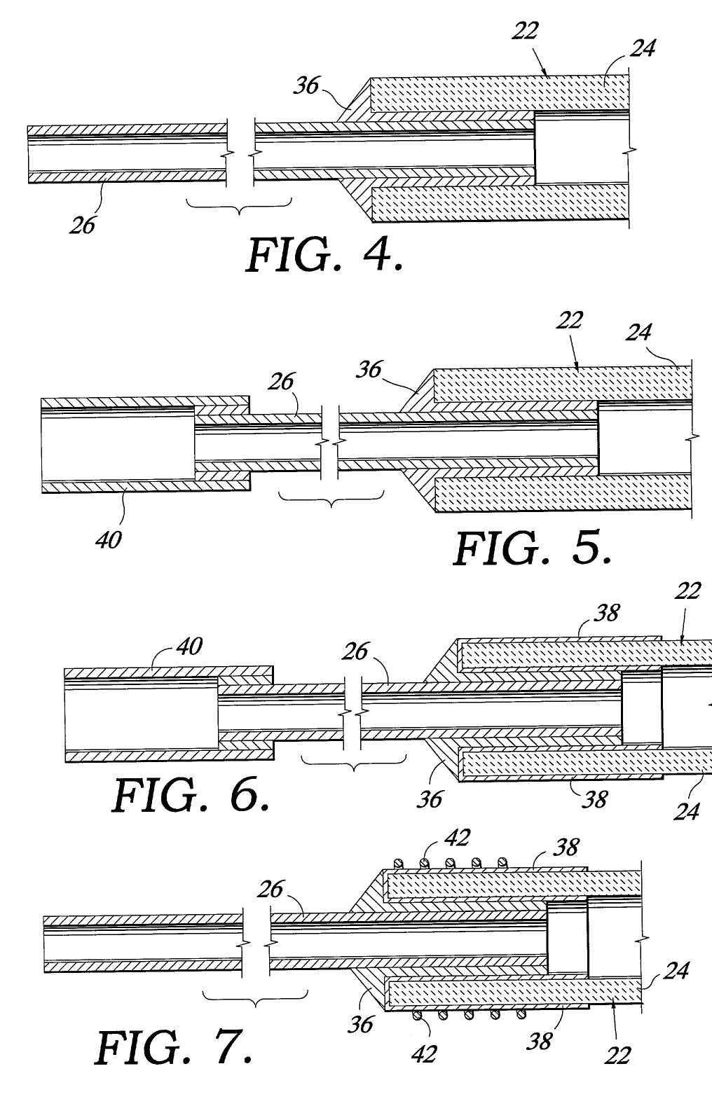

Turning additionally to FIGS. 3-7, the filtration module 10 comprises a plurality of hollow, straw-like, filtration elements 22 that are bundled together and extend longitudinally in parallel and spaced apart relationship within the housing 12. The filtration elements 22 include elongated, cylindrical or tubular walls 24 that comprise a layer of a porous, semipermeable mineral-based membrane which can be a reverse osmosis, nanofiltration, ultrafiltration, or microfiltration membrane and permits passage of the permeate stream through the membrane layer and the wall of the element 22 while rejecting passage of the concentrate stream. The walls 24 will typically include a layer of a porous, permeable, mineral-based substrate on which the semipermeable membrane is applied and supported. The membrane and substrate layers of walls 24 are preferably formed from carbon-carbon composite; carbon, graphite and composites based on these materials; ceramic; or other minerals in one or more conventional processes which form no part of the present invention.

The number and length of the individual filtration elements 22 utilized in the module 10 can be varied to suit the fluid flow rates and flux requirements of particular applications. Similarly, two or more modules 10 can be placed end to end, or in parallel to each other, to achieve greater flow and flux capacity.

In accordance with the present invention, the filtration module 10 includes interconnect tubes 26 which join the opposite ends of each filtration element 22 to a pair of spaced apart tubesheets 28 located at opposite ends of the module 10. The interconnect tubes 26 and tubesheets 28, as well as the housing 12, are formed of one or more metallic materials which are compatible with and resist attack by the fluid streams to which they are exposed during use of the filter 13. For severe service applications, stainless steel, inconel, and hastalloy alloys are generally preferred because of their corrosion resistance.

The metallic tubesheets 28 have a plurality of axially extending fluid passages 30 that extend between the opposed axial faces of the tubesheets to permit fluid to flow axially through the tubesheets at the location of the passages 30. The ends of the interconnect tubes 26 opposite from the ends joined to the filtration elements 22 are attached to the metallic tubesheets 28 in a manner which forces all of the fluid exiting the tubesheet passages 30 to flow axially through the interconnect tubes 26. This may be accomplished in any suitable fashion that prevents leaks from forming around the outer diameter of the interconnect tubes 26 during use of the filter 13. For example, the filtration elements 22 may have an outer diameter and a length which allows them to be inserted a preselected distance into or completely through the tubesheet passages 30 with a sealed joint then being formed between the interconnect tubes 26 and tubesheets 28 by welding, soldering, brazing, interconnect tube 26 roller expansion onto the tubesheet 28, heating the tubesheet 28 and shrink cooling over the interconnect tubes 26, threading the end of the interconnect tubes 26 past the tubesheet 28 and sealing with a nut and gasket or using a compression fitting. Alternatively, the interconnect tube 26 can be omitted entirely and the end of the filtration element 22 can be secured directly to the tubesheet by a compression fitting or by threading the end of the filtration element and securing the threaded end directly to the tubesheet using a nut or threaded opening.

The metallic tubesheets 28 have an outer diameter sized slightly less than the inner diameter of the pressure housing 12 so that the module 10 can slide axially within the pressure housing during installation and removal and during operation where differences in the coefficients of thermal expansion of the module 10 and housing 12 must be accommodated. An O-ring or other shaped sealing element 32 fashioned from EPDM, graphite or other materials resistant to the temperatures and conditions within the filter 13 may be carried about the outer diameter of each tubesheet 28 and received within a groove 34 formed in housing 12 to seal the tubesheet 28 against the inner diameter of the housing. In another embodiment, the tubesheet 28 and flange 16 may be one piece and welded to the pressure housing 12 so that no elastomeric or graphite seal is required. An expansion joint may be incorporated in the wall of the pressure housing 12 to accommodate differences in the coefficients of thermal expansion of the module 10 and housing 12.

The ends of the filtration elements 22 are sealingly joined by a joint or seal 36 to the ends of the interconnect tubes 26. The seal 36 is preferably formed using a metal alloy but can also be formed by a compression fitting or threading the joining ends of the filtration elements 22 and interconnect tubes 26. Preferably, the outer diameter of the interconnect tubes 26 is slightly less than the inner diameter of the filtration elements 22 to allow the interconnect tubes 26 to be axially inserted a preselected distance into filtration elements 22 prior to or during formation of the seal 36. Alternatively, the inner diameter of the interconnect tubes 26 can be slightly greater than the outer diameter of filtration elements 22 so the filtration elements 22 may be inserted within the interconnect tubes 26. In either case, the difference in diameters should be enough to form a slight gap which is then filled by the metal alloy 36. Preferably, the seal 36 extends beyond the area of overlap between the filtration elements 22 and interconnect tubes 26 to ensure that a strong seal is formed which is not compromised under the temperatures, pressures and forces experienced during operation of the filter 13. The seal 36 can be formed before or after the final membrane coating has been applied to the filtration element 22. If the seal 36 is applied before final processing of the filtration element 22, the metal alloy must have a liquidus temperature above the temperatures employed in the final processing of the filtration element. Similarly, care must be taken to ensure that formation of the seal 36 does not subject the filtration elements 22 to temperatures that may change the desired properties of the filtration elements 22.

The metal alloy selected to form seal 36 must be capable of forming the desired bonds with the interconnect tubes 26 and the filtration elements 22 and should have a permeability equal to or less than the permeability of the filtration elements 22. In addition, the alloy should be resistant to attack from the organic chemicals and solvents and aqueous chemicals, acids and bases which may be present in the filter 13. The alloy should also have a liquidus temperature above the maximum desired operating temperature for the filtration module 10.

In order to form a secure bond between the metal alloy and the filtration elements 22, the metal alloy should contain at least one component that wets and or chemically bonds with the carbon or ceramic present in the filtration element 22. The wetting component can be the primary alloying metal, or a minor component in another metal. As an example, when the filtration element 22 is formed from carbon, the wetting component can comprise a non-metal such as glass, or one or more metal or metallic components selected from the group consisting of nickel, palladium, platinum, iron, chromium, manganese, vanadium, titanium, zirconium, niobium, molybdenum, hafnium, tantalum, tungsten, rhenium, ruthenium, osmium, aluminum, silicon, silver, iridium and cobalt. These metals are known to readily dissolve carbon and, as the primary alloying metal, or as a minor component in another metal, will promote wetting of the carbon by the molten metal. Alternatively, such elements will also bond with the carbon by solid state diffusional reactions. Such alloying or chemical reaction promotes a strong bond between the carbon membrane and the metal filler alloy. The preferred wetting agent for carbon-based filtration elements 22 is chromium. In the case of ceramic-based filtration elements 22, the wetting agent may include a non-metal such as glass, or metals such as zirconium and/or titanium. The amount of wetting agent present in the metal alloy can be present in any suitable amounts, but commonly does not exceed 35% by weight of the alloy.

Because the hollow filtration elements 22 are porous and permeable, steps must be taken to prevent the metal alloy from wicking away from the desired joint site under the capillary action of the fine pores and channels in the filtration elements. In one approach, a temperature gradient is formed by inductively or otherwise heating only those portions of the interconnect tubes 26 and filtration elements 22 at the joint site to a temperature above the liquidus temperature of the metal alloy. The temperature gradient allows the metal alloy to flow into the capillary sized pores and channels of the filtration elements 22 at the joint site, but it solidifies only a short distance away from the joint site when it reaches a temperature below its melting point. As a result, the solidified metal alloy blocks further wicking of the alloy away from the joint site.

Another approach to preventing undesired wicking of the metal alloy into the filtration elements 22 involves the use of refractory small solid particles in the molten metal alloy. These refractory small solid particles act to block the pores in the semipermeable filtration elements 22, thereby reducing or eliminating the ability of the filtration elements 22 to wick away the liquid metal alloy from the joint site. The refractory small solid particles can be added to the metal alloy by direct mixing, or can be formed by a chemical reaction involving components of the metal alloy and/or the filtration elements 22. For example, tantalum, niobium, lanthanum, cerium and/or tungsten can be added to the metal alloy in amounts up to about 10% by weight based on the total weight of the alloy. These elements in solution in the liquid metal alloy react on contact with carbon present in the alloy or filtration elements 22 to form strong stable refractory carbides. These carbides rapidly block the capillary pores in the permeable filtration elements 22 and restrict filler metal penetration. When the filtration elements are ceramic rather than carbon based, aluminum may be added to the metal alloy to form oxides which precipitate and form refractory small solid particles. Alternatively, various glasses can be added as refractory small solid particles to block the pores in ceramics.

The metal alloy can include other components commonly present in solders and brazes such as a filler selected from nickel, silver, copper, lead, chromium and other metals. Melting point depressants such as silicon, boron and/or phosphorous can also be present in order to achieve the desired liquidus and solidus temperatures for the alloy. A particularly preferred metal alloy for use with carbon filtration elements 22 comprises a predominantly nickel and chromium alloy, with silicon, boron or phosphorus added as melting point depressants. A specific example of such a metal alloy has a nominal composition of 25% chromium, 10% phosphorous, and the balance nickel with a melting point solidus temperature of 1620° F. and a liquidus temperature of 1740° F. Such an alloy is sold commercially as NICROBRAZ 51 High-Temperature Brazing Filler Metal by Wall Colmonoy Corp. of Madison Heights, Mich. Another example of a preferred metal alloy has a nominal composition of 19% chromium, 10.2% silicon, 0.6% maximum carbon, and the balance nickel with a melting point solidus temperature of 1975° F. and a liquidus temperature of 2075° F. This alloy is sold commercially as NICROBRAZ 30 High-Temperature Brazing Filler Metal by the same manufacturer.

If desired, the inner and/or outer surfaces of the ends of the filtration elements can be coated with a metallic layer 38 as shown in FIGS. 3, 6 and 7 to form a coherent metallic layer to which the metal alloy seal 36 is attached. The metallic layer 38 can be applied using any suitable technique, such as electroless plating, electroplating, chemical vapor deposition, physical vapor deposition, reactive brazing, molten metal immersion and casting. For example, carbon filtration elements were successfully metallized by electroplating with silver, gold, platinum and nickel, by physical vapor deposition with stainless steel, and by electroless nickel deposition. The metallic layer 38 is preferably electroless nickel but can be formed alternatively or additionally from one or more other metals or techniques. The metallic layer 38 advantageously allows the seal 36 between the filtration elements 22 and interconnect tubes 26 to be formed from metal alloys which are capable of wetting and bonding to the metal selected for the metallic layer 38. For example, various solders such a lead-tin, tin-silver and antimony-tin alloys may be used to form seal 36. In particular, a strong solder seal 36 has been formed between carbon-based filtration elements 22 and stainless steel interconnect tubes 26 by forming an electroless nickel metallic layer 38 and applying a Ag/Sn solder sold by Eutectic-Castolin Inc. under the trademark STAINTIN 157-PA. This solder comprises 96.2% tin and 3.8% silver with a melting range of 425-435° F. The flux used was approximately 35% zinc ammonium chloride in glycol and water.

It has been found that the seal 36 formed between the interconnect tubes 26 and filtration elements 22 may fail as a result of the differences in coefficients of thermal expansion possessed by the interconnect tubes 26 and filtration elements 22. For example, when an interconnect tube 24 made from a 300 series stainless steel was heated and joined to a carbon based filtration element 22 by soldering or brazing, the resulting seal 36 failed upon cooling because the length and diameter of the stainless steel interconnect tube changed by a greater amount than the carbon based filtration element 22. The failure occurred in the filtration element 22 in some instances and between the metallized coating 38 and the filtration element 22 in other instances, causing a channel to form which allowed passage of fluid and destroyed the integrity of the filtration module 10.

In brazing applications with carbon based filtration elements, in order to prevent seal failure resulting from differences in coefficients of thermal expansion, it is desirable for the interconnect tubes 26 to be formed from materials having coefficients of thermal expansion which are within approximately 10 ppm (parts-per-million) per degree centigrade and preferably 5 ppm per degree centigrade to that of the coefficient of thermal expansion of the filtration elements 22. For ceramic tubular membranes, which are more brittle than carbon, it may be required that the coefficient of thermal expansion of the metal interconnect tube 26 be within approximately 5 ppm per degree centigrade and preferably 2.5 ppm per degree centigrade to that of the coefficient of thermal expansion of the ceramic based filtration element. As an example, type 439 stainless steel has a coefficient of thermal expansion which is within 10 ppm per degree centigrade of the coefficient of thermal expansion of graphite. An interconnect tube 24 formed from type 439 stainless steel and inserted to a depth of 0.5 inches within the carbon based filtration element 22 was inductively brazed with NICROBRAZ 51 metal alloy, a strong and leak free seal formed that did not fail under a tensile load of 1530 pounds. As another example, molybdenum has a coefficient of thermal expansion that is within 5 ppm per degree centigrade to that of graphite. A molybdenum interconnect tube inserted into the carbon based filtration element and inductively brazed with NICROBRAZ 51 brazing metal alloy, yielded a strong and leak free seal that did not fail under a tensile load of 2000 pounds. If desired, as shown in FIGS. 5 and 6, the molybdenum may form only that portion of the interconnect tube 24 attached to the filtration element and may itself be joined to another tube 40 formed of material such as stainless steel. The stainless steel tube is, in turn, joined to the tubesheet 26.

In soldering applications, it is not as important to closely match the coefficients of thermal expansion because the solder is capable of relieving the thermal strains by creep whereas the brazing alloys do not creep at the operating temperatures of the filter 13 or at room temperature.

Another approach to reducing seal failure as a result of differences in coefficients of thermal expansion is to apply a compressive force to the outer surface of the filtration element 22 during the seal 36 cooling cycle when the interconnect tube 24 is attached to the inside diameter of the filtration element 22. Similarly, when the interconnect tube 24 is attached to the outside diameter of the filtration element 22, an expansion force may be applied to the inside diameter of the filtration element 22 during the seal 36 cooling cycle. The compressive and expansive forces can be applied in any suitable fashion, such as illustrated in FIG. 7 where a compressive force is applied by a coil spring 42 wound about the outer surface of the filtration element. A carbon based filtration element 22 was plated with electroless nickel and a 316 type stainless steel interconnect tube 24 was inserted 0.5 inches within the filtration element. The coil spring 42 was applied and the assembly was soldered together using STAINTIN 157-PA solder by heating the stainless steel interconnect until the solder filled the joint. The assembly was cooled and the coil spring was removed. Leak testing established that the soldered seal did not leak.

### EXAMPLE 1

Tantalum powder is added to NICROBRAZ 51 brand metal alloy. Furnace brazing using the resulting metal alloy on a stainless steel interconnect tube 26 and a permeable carbon filtration element 22 forms a strong, non-porous bond, with wicking of the filler metal deep into the filtration element being prevented by the refractory carbides formed by reaction of tantalum with carbon. A resulting seal between the interconnect tube was impermeable, stable at high temperature and resistant to chemical degradation in severe service filtration application environments.

### EXAMPLE 2

The procedure of Example 1 was repeated using niobium in place of tantalum. An impermeable, stable and corrosion resistant seal is formed.

From the foregoing it will be seen that this invention is one well adapted to attain all ends and objects hereinabove set forth together with the other advantages which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

Having thus described the invention, what is claimed is:

1. A filtration assembly comprising:
an elongated hollow filtration element comprising a wall which forms an inner axial fluid flow passage, said wall being semipermeable to permit permeation flow of a solvent and solutes of a preselected size through the wall while rejecting passage of larger solutes and suspended solids, said wall having longitudinally opposite ends and being formed of carbon or ceramic based materials;
a metallic interconnect tube having a preselected axial length; and
means for sealing the interconnect tube to one of the ends of the wall of the filtration element.

2. The filtration assembly of claim 1, including a second metallic interconnect tube and means for sealing the second interconnect tube to the other end of the wall of the filtration element.

3. The filtration assembly of claim 2, wherein said interconnect tubes are axially aligned with the filtration element and are inserted a preselected axial distance within said wall of the filtration element.

4. The filtration assembly of claim 3, wherein said means comprises a seal formed from a metal alloy containing at least one metallic component that wets or reacts with a component of the wall of the filtration element.

5. The filtration assembly of claim 4, wherein said metal alloy comprises a mixture of nickel and chromium.

6. The filtration assembly of claim 3, wherein said means includes a metallized coating on the ends of the filtration element.

7. The filtration assembly of claim 6, wherein said metallized coating comprises nickel.

8. The filtration assembly of claim 1, wherein said interconnect tube and said filtration element have coefficients of thermal expansion that are within approximately 10 parts per million per degree centigrade.

9. The filtration assembly of claim 1, wherein said filtration element is selected from the group consisting of reverse osmosis, nanofiltration, ultrafiltration and microfiltration membranes.

10. A filter comprising:
a housing having an axial length;
a filtration module within said housing and comprising:
(a) spaced apart tubesheets sealed against an inner surface of the housing and having fluid flow passages formed therein;
(b) a plurality of elongated hollow filtration elements extending between the tubesheets, at least one of said filtration elements comprising a wall which forms an inner axial fluid flow passage, said wall being semipermeable to permit permeation flow of a solvent and solutes of a preselected size through the wall while rejecting passage of larger solutes and suspended solids, said wall having axially opposite ends and being formed of carbon or ceramic; and
(c) means for sealing the filtration elements to the tubesheets.

11. The filter of claim 10, wherein said means comprises metallic interconnect tubes joined at opposite ends to the filtration elements and the tubesheets and in fluid communication with said passages in the filtration elements and tubesheets.

12. The filter of claim 11, including means for sealing the interconnect tubes to the walls of the filtration elements.

13. The filter of claim 12, wherein said interconnect tubes are axially aligned with the filtration elements and are inserted a preselected axial distance within said walls of the filtration elements.

14. The filter of claim 13, wherein said means for sealing comprises a seal formed from a metal alloy containing at least one metallic component that wets or reacts with a component of the walls of the filtration elements.

15. The filter of claim 14, wherein said metal alloy comprises a mixture of nickel and chromium.

16. The filter of claim 13, wherein said means for sealing includes a metallized coating on the ends of the filtration elements.

17. The filter of claim 16, wherein said metallized coating comprises nickel.

18. The filter of claim 11, wherein said interconnect tubes and said filtration elements have coefficients of thermal expansion 5 parts per million per degree centigrade.

19. The filter of claim 11, wherein said filtration element is selected from the group consisting of reverse osmosis, nanofiltration, ultrafiltration and microfiltration membranes.

20. A method of forming a filtration assembly comprising:
inserting a metallic interconnect tube a preselected axial distance within an end of an elongated hollow filtration element comprising a wall which forms an inner axial fluid flow passage, said wall being semipermeable to permit permeation flow of a solvent and solutes of a preselected size through the wall while rejecting passage of larger solutes and suspended solids, said wall being formed of carbon or ceramic;
heating at least a preselected portion of the metallic interconnect tube and filtration element to a temperature above a liquidus temperature of a preselected metal alloy;
forming a sealing joint between the interconnect tube and the filtration element by heating the metal alloy to a liquid form, spreading it about the preselected portion, and then allowing the spread metal alloy to cool to a temperature below a solidus temperature of the metal alloy.

21. The method of claim 20, including the step of applying a compressive or expansive force to the wall of the filtration element during said cooling of the metal alloy.

22. The method of claim 20, including the step of applying a metallized coating to the preselected portion prior to said step of forming a sealing joint.

23. The method of claim 20, wherein said step of heating comprises heating said preselected portion and creating a temperature gradient in the filtration element which causes said spread metal alloy to cool to a temperature below said solidus temperature as it travels along said temperature gradient.

24. The method of claim 20, including the step of adding or forming refractory small solid particles in the metal alloy.

25. The method of claim 20, including the step of selecting the interconnect tube material and the filter element having coefficients of thermal expansion that are within approximately 10 parts per million per degree centigrade.
